(19) United States
(12) Patent Application Publication
(10) Pub. No.: US 2015/0037484 A1
(43) Pub. Date: Feb. 5, 2015

(54) Methods and Compositions Related to French Fry Dough and Products Thereof

(71) Applicant: Elwha LLC, Bellevue, WA (US)

(72) Inventors: Chris Cvetkovich, Seattle, WA (US); Scott Heimendinger, Seattle, WA (US); Jeth Rollins Odom, Seattle, WA (US)

(21) Appl. No.: 13/954,077

(22) Filed: Jul. 30, 2013

(51) Int. Cl. A23L 1/217; A23L 1/00

(52) U.S. Cl. CPC A23L 1/217; A23L 1/0076; A23L 1/007
USPC 426/549

(57) ABSTRACT

Disclosed herein include embodiments related to an ultra-high surface area French Fry product extruded from dough by a device and requiring a fraction of the cooking time compared with standard French fries, as well as producing a French Fry product that is crispier than standard French fries.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### Priority Applications

None.

### Related Applications

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

Methods and compositions are included herein that describe an ultra-high surface area French Fry made of dough including dehydrated pre-gelatinized potato flakes or other dehydrated pre-gelatinized starchy flakes. Certain embodiments relate to a French Fry product that cooks in a fraction of the cooking time of standard French fries. Certain embodiments relate to flavored French fries, wherein the flavoring is included in at least one of the surface or intermixed with the dough. Certain embodiments relate to methods relating to extruding the French Fry dough through a die press, or similar extrusion device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a partial view of a close-up fresh product in an embodiment.

FIG. 2 is a partial view of a close-up cooked product in an embodiment.

FIG. 3 is a partial view of a cooked product in an embodiment.

FIG. 4 is a partial view of fresh and cooked products in an embodiment.

FIG. 5 is a partial view of cooked products in an embodiment.

FIG. 6 is a partial view of cooked products in an embodiment.

FIG. 7 is a partial view of a close-up cooked product in an embodiment.

FIG. 8 is a partial view of a close-up cooked product in an embodiment.

FIG. 9 is a partial view of a method of making a product in an embodiment.

FIG. 10 is a partial view of a close-up fresh product in an embodiment.

FIG. 11 is a partial view of a close-up fresh product in an embodiment.

FIG. 12 is a partial view of a close-up fresh product in an embodiment.

FIG. 13 is a partial view of a close-up fresh product in an embodiment.

FIG. 14 is a partial view of a close-up fresh product in an embodiment.

FIG. 15 is a partial view of a close-up fresh product in an embodiment.

FIG. 16 is an example of a method embodiment and the resulting product therefrom.

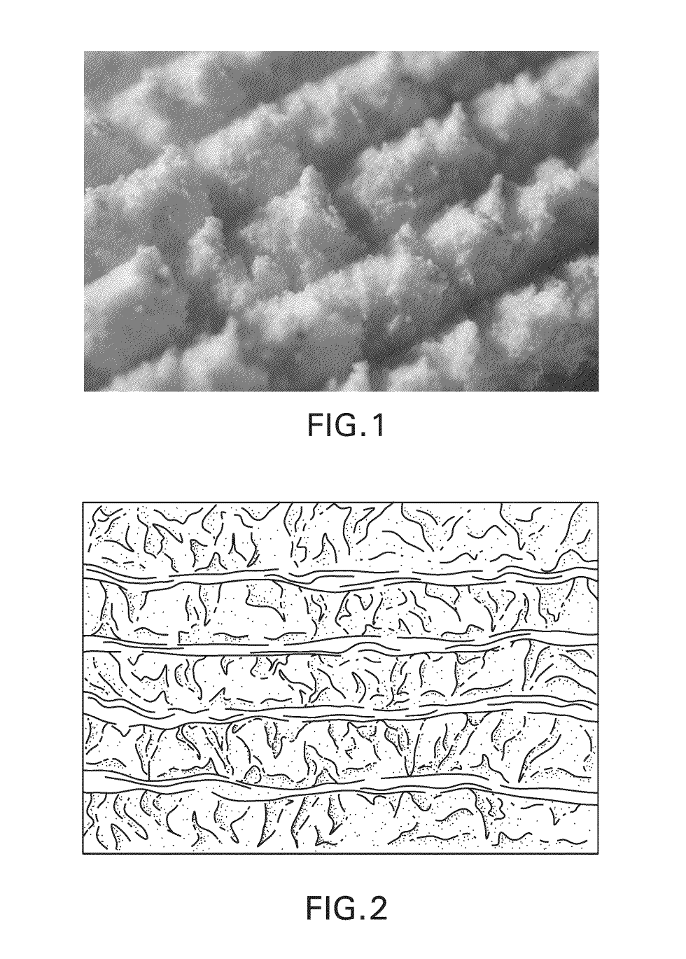

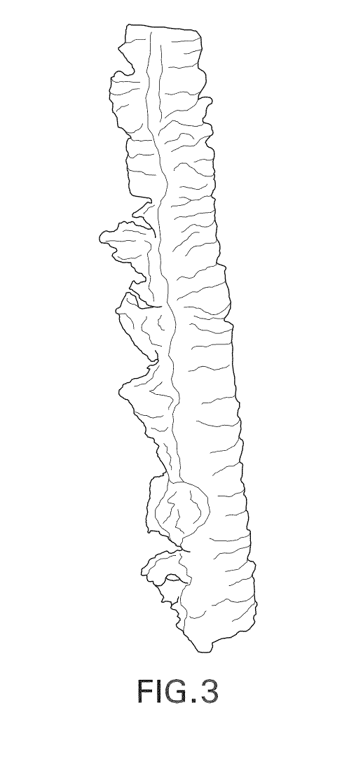

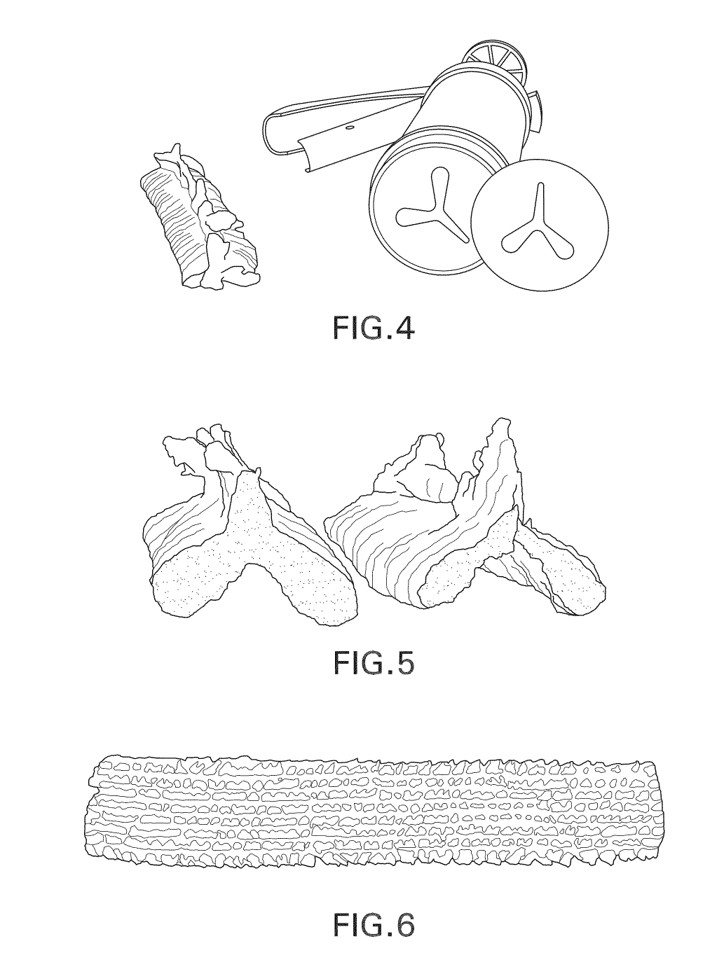

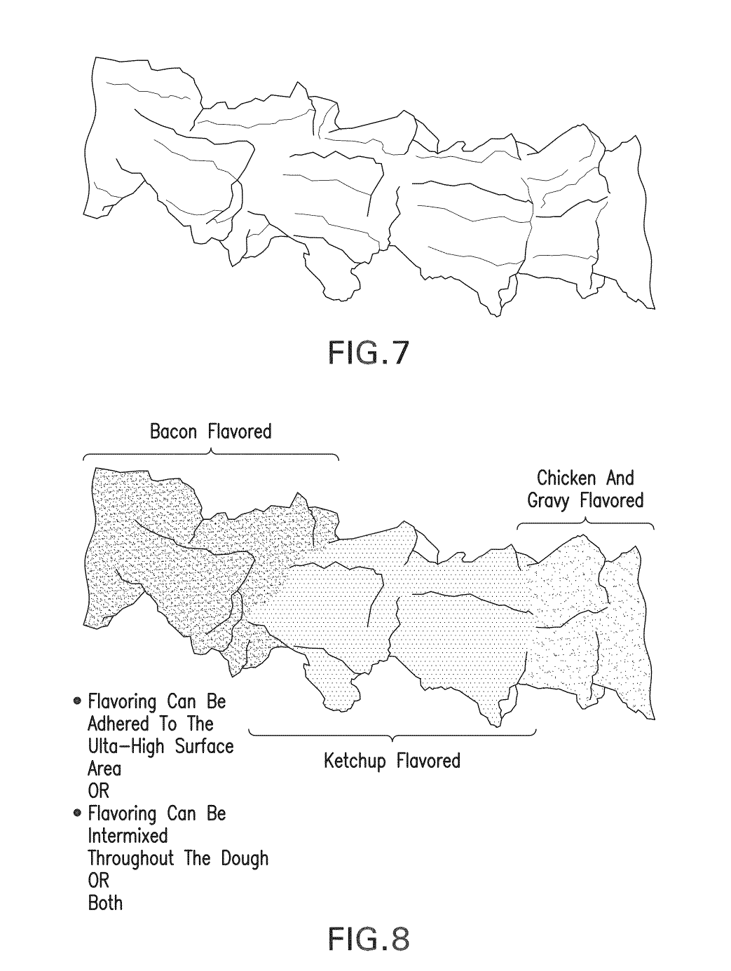

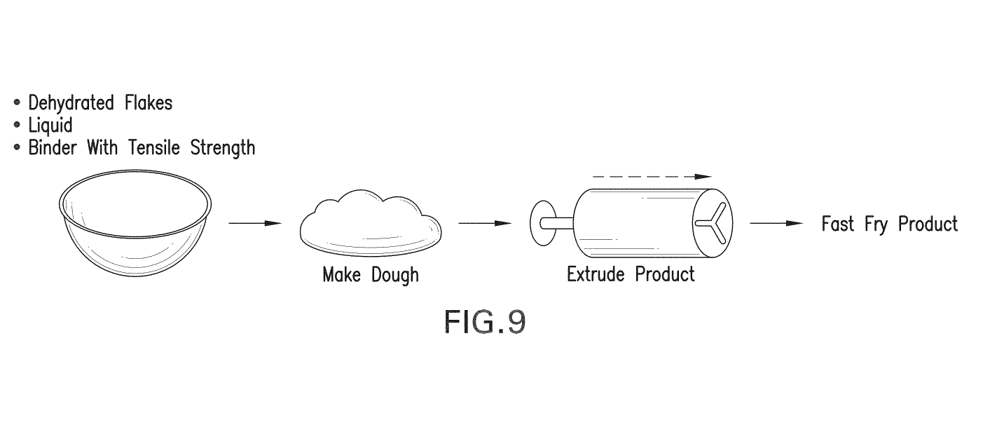

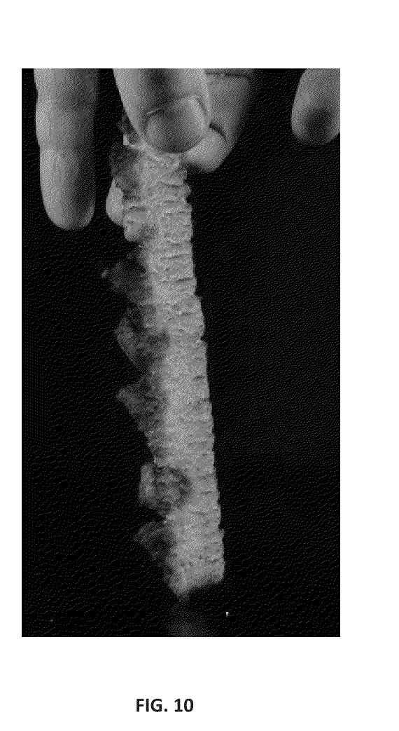

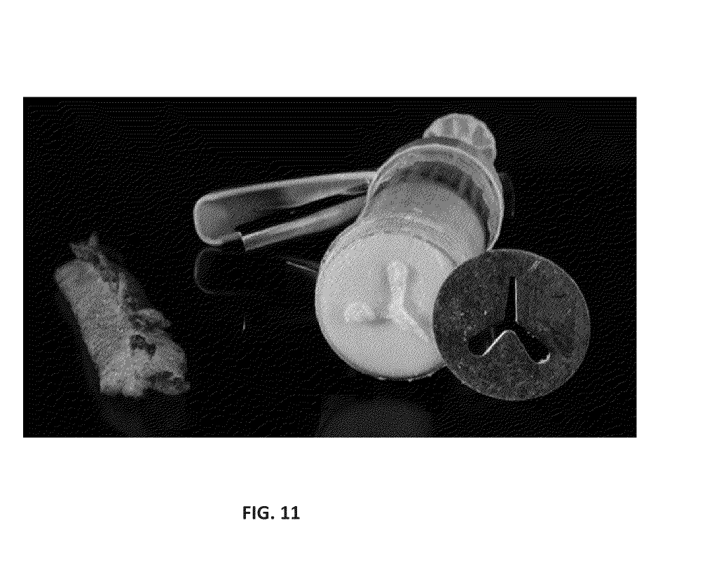

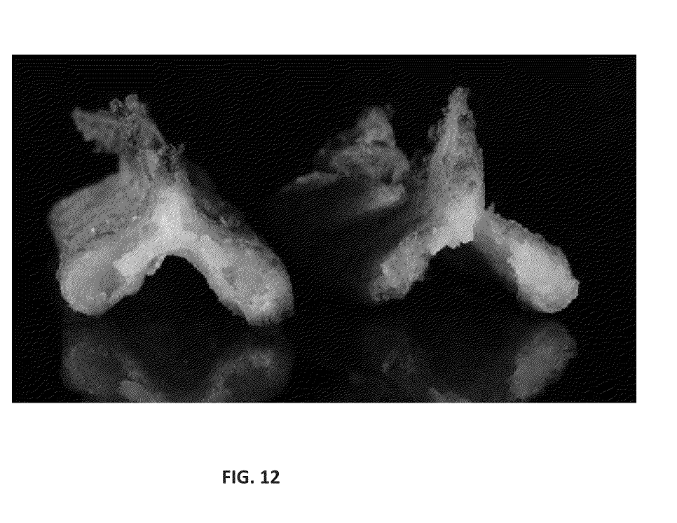

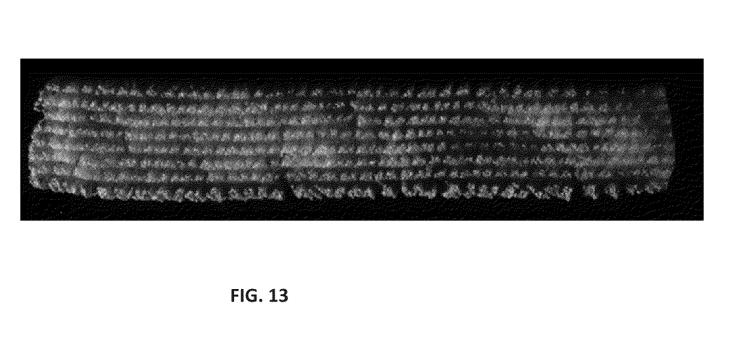

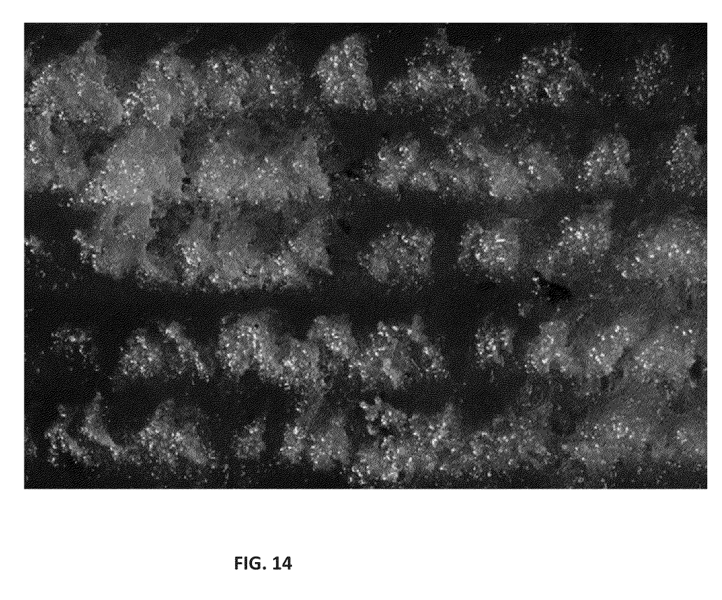

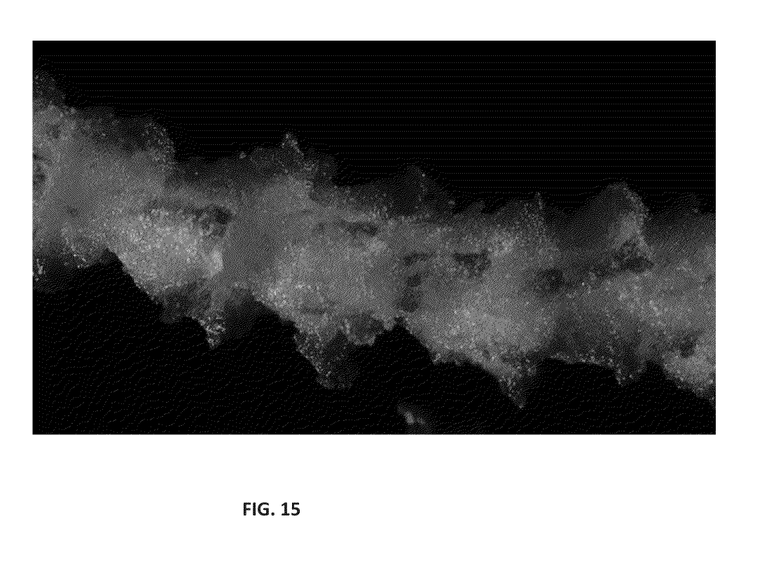

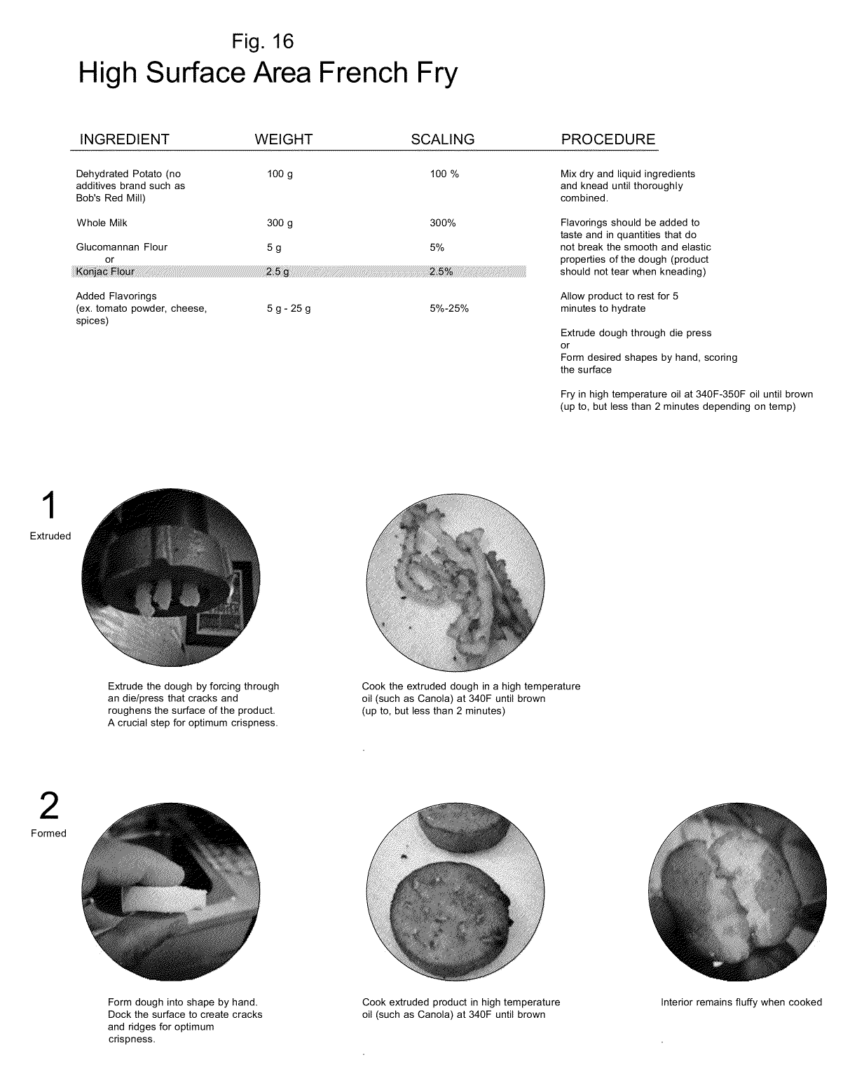

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Fried dough products, particularly farinaceous fried dough products are highly desirable due to the ability to eat them “on the go,” as they can be eaten with the hands. Doughs used to make various hash browns and other starchy products have faced obstacles due to the processing of conventional potato flakes. This is due, in part, because conventional potato flakes are processed under conditions such that the resulting flakes have a high level of broken cells with the resulting high level of amylopectin and free amylose. Conventional processing also produces flakes with low levels of potato flavor and high levels of processed flavor. Under standard conditions, conventional potato flakes are produced by first washing, peeling and sorting the potatoes. The potatoes are sliced, cooked, riced, drum dried, and reduced to particles. The cooking, ricing, drying, and reduction steps increase the number of broken potato cells, and generates a large level of overcooked amylopectin and free amylose.

Thus, typically when potato flakes are used in dough, the amylose acts as an adhesive and forms an elastic cohesive dough that is difficult to form into sheets or other products. With the high levels of overcooked amylopectin, the products of the dough are hard, dense, and glass-like since the dough fails to absorb much water, which is undesirable. Due to this, and other factors, conventional potato flakes do not form a good dough that produces a desired end product. See, for example, U.S. Pat. No. 6,287,622, which is incorporated herein by reference.

Certain embodiments disclosed herein overcome this problem, as well as others now hindering development of potato flake dough products. The various compositions described herein include extruded French fries, but also include other farinaceous products which are sheeted or extruded (e.g., chips, pretzels, crackers, French fries, cookies, coatings on meat (e.g., corndogs), hash browns, waffle fries, tater tots, and the like).

In an embodiment, one or more hydrocolloids are added in order to create an elastic network that binds potato flake components and provides tensile strength. Non-limiting examples of hydrocolloids include konjac, egg whites, carrageenan, furcellaran, alginate, gum Arabic, gum ghatti, gum tragacanth, karaya gum, guar gum, locust bean gum, tara gum, tamarind gum, inulin, arabinoxylans, b-glucans, xyloglucans, pectin, cellulose, curdlan, dextran, gellan gum, rhamsan gum, scleroglucan, welan gum, xanthan gum, carboxymethylcellulose, hydroxypropyl cellulose, hydroxypropyl methyl cellulose, hydroxyethyl cellulose, propylene glycol alginate, hydroxypropyl guar, modified starches, and mixtures thereof. Such hydrocolloid is included in the dough at approximately 0.01%, approximately 0.1%, approximately 1%, approximately 5%, approximately 10%, approximately 20%, approximately 25%. Depending on the entire constitution of the dough, the hydrocolloid concentration should be high enough to provide the strength that keeps the dough from falling apart, but not so high that the dough is too firm to be extruded.

In an embodiment, a binder, such as a polymer protein, is utilized to allow for strength and flexibility to the dough. A hydrocolloid may provide this function, as described, or various proteins can serve as binders, such as konjac flour or meal, or glucomannan flour or meal. These flours are gluten free, and provide soluble fiber, and are highly absorbant, which contributes to the crispness of the end product.

In an embodiment, other flours or meals may be added for increased texture or nutrition, including for example, soy flour or meal, wheat flour or meal, nut flour or meal (e.g., flours or meals made of almond, hazelnut, peanut, chestnut, pistachio, cashew, sunflower seed, pine nuts, etc.), hempseed flour or meal, pecan flour or meal, flax flour or meal, barley flour or meal, black chia seed flour or meal, rice flour or meal, brown rice flour or meal, corn flour or meal, oat flour or meal, coconut flour or meal, wheat germ meal, quinoa flour or meal, coffee flour or meal, buckwheat flour or meal, or the like.

In an embodiment, flours or meals are included in the extruded product at approximately 0.025%, approximately 0.05%, approximately 0.25%, approximately 0.5%, approximately 1%, approximately 5%, approximately 10%, approximately 15%, approximately 20%, approximately 25%, approximately 30%, approximately 35%, approximately 40%, approximately 45%, approximately 50%, approximately 55%, approximately 60%, approximately 65%, approximately 70%, approximately 75%, approximately 80%, approximately 85%, approximately 90%, or any value therebetween.

In an embodiment, the extruded product is gluten-free.

In addition, certain embodiments described herein related to a dough made with starchy flakes of potatoes or other foods in which the starch of the potato or other food is pre-gelatinized. This reduces the frying to from approximately 1-2 minutes for standard French Fry potatoes to approximately 30 seconds, or even less.

In an embodiment, since the French fries are extruded from a dough, flavoring may be added to the product either as a coating, due to the ultra-high surface area from the extrusion process, or the flavoring may be intermixed within the dough itself, just as in a cookie dough. Further, a flavoring may be added to only a part of the product, with another flavoring or no flavoring on any other part of the product. In an embodiment, multiple flavorings are intermixed in the dough such that the product includes a sequence of different flavorings horizontally or vertically in the product. In an embodiment, multiple flavorings are intermixed in the dough such that the end taste includes nuances of the multiple flavorings throughout the product. In an embodiment, one or more flavorings are intermixed within the dough, while one or more flavorings is coated on the outside of the product. In an embodiment, two or more flavorings is coated on the outside of the product in a sequence or pattern. In an embodiment, one or more flavorings is coated on the outside of the product. In an embodiment, one or more flavorings is coated on the outside of the product such that it penetrates into the product due to the ultra-high surface area of the product.

Any desired flavoring may be added to the French fries, including but not limited to ketchup, salt, pepper, bacon, wasabi, horseradish, sugar, chicken, gravy, biscuits, vinegar, pickle, cheesy garlic, cheese, garlic, ginger chicken, beef, lime, sour cream and onion, onion, barbecue, spicy Thai barbecue, cheese and onion, salt and vinegar, chocolate, curry, beer, cheddar beer, chai, strawberry cream, cherry cream, orange cream, citrus (orange, tangerine, lemon, lime, grapefruit, etc.), other fruit (berry, apple, pear, kiwi, watermelon, strawberry, cherry, mango, pineapple, guava, apricot, peach, blueberry, raspberry, etc.), coffee, tea, peanut butter, hot dog, ham, pork, sausage, cinnamon, cloves, wine, pesto, honey Dijon, jalapeno, tequila, roasted red pepper, goat cheese, salsa, mesquite, hickory, mustard, honey, chipotle chili barbeque, crab, green chile, habanero, sweet potato, cinnamon and sugar, rosemary, basil, thyme, oregano, fish, carrot, beet, taro, green bean, broccoli, cilantro, vanilla, or Yukon gold. These flavorings may be added, for example, in the form of whole ingredients, synthetic flavorings, or processed foods, and may be in the form of a solid, liquid, or gel. In an embodiment, the flavorings are intermixed with the dough. In an embodiment, the flavorings are layered with the dough. In an embodiment, the flavorings are added to the outside of the dough or extruded product.

In an embodiment, the flavorings that are layered with the dough may also be co-extruded with the dough. That is, two or more doughs are made and co-extruded together. For example, at least one first dough is extruded with a die creating a filling or layering that is extruded inside of at least one second dough that is being extruded with a die that would otherwise maintain a hollow center or core, thus creating a layered or filled extruded product. In an embodiment, the flavorings are injected into the extruded product.

In addition, the ultra-high surface area of the product allows for increased capture of condiments or coated flavorings. Also, the product may be made in the form of an extruded or sheet product many times larger than the standard French fries, allowing for ease of handling and increased ability to hold condiments on the outside of the product or in one or more wells produced by the extrusion and fast frying process.

In an embodiment, the center of the product is hollow, thus allowing for filling of condiments (e.g., ketchup), flavoring as described herein, fruit or vegetables or purees thereof, or meat (e.g., hot dog, ham, sausage, chicken, etc.).

In an embodiment, the extruded product is generated at a much larger size than the standard French fry or other vegetable stick. In an embodiment, the extruded product is large enough to fill a human hand, thereby having the benefit of being able to be eaten as “finger food,” with plenty of room for added condiments (e.g., ketchup, mustard, or the like), or on a stick, for example.

In an embodiment, the product is extruded as an encapsulated or layered product. For example, the materials constituting the final extruded product may be layered with different base materials (dough may be made from potato flakes or flakes of other starchy foods with dehydrated, pre-gelatinized starch such as yucca, corn, sweet potatoes, carrots, beets, tofu, pinto beans, fava beans, garbanzo beans, or the like and these doughs may be layered on each other or intermixed prior to extrusion, such that a layered, or mixed product is produced). Additionally, thin layers of other materials may be layered among or on top of one or more dough layers (e.g., thin slices of meat, ginger, spices, condiments, colors, flavors, vitamins, minerals, nutraceuticals, etc.).

In an embodiment, the extruded product may be extruded in various shapes and forms, including geometric shapes (cones, cylinders, sticks, stars, circles, squares, rectangles, etc.), animal shapes (including cartoon characters, etc.), or can be sheeted as patties, pancakes, chips, or other forms.

In addition, the extruded product may be shaped following extrusion. For example, the shaping may include bending, folding, coning, imprinting, or the like.

In an embodiment, the extruded product is utilized as a food for humans, pets, or other animals. In an embodiment, the extruded product is flash-frozen (e.g., with carbon dioxide or liquid nitrogen) prior to cooking In an embodiment, the extruded product is at least partially cooked (e.g., fried or baked) and then flash-frozen. In an embodiment, the extruded product is included as part of a frozen meal, snack, or other frozen food that is re-heated or cooked just prior to eating. In an embodiment, the extruded product is cooked immediately (e.g., fried or baked).

In an embodiment, the extruded product is deep fried in standard cooking oil, fat, or in a mixture of standard cooking oil, fat, and non-digestible oil. Standard cooking oil (e.g., canola oil, peanut oil, or other oil with a smoke point above 350° F. including low calorie fat-like materials such as described in U.S. Pat. Nos. 3,600,186; 4,005,195; 4,005,196; 4,034,083; or 4,241,054; each of which is incorporated herein by reference) or non-digestible oil (e.g., polyol fatty acid polyesters) may be partially or fully non-digestible.

In an embodiment, the extruded product is fried in a pan, deep fryer, pressure fryer, or vacuum fryer.

In an embodiment, the extruded product is fried in hot oil (e.g., deep fried), at a temperature of between approximately 340-375° F., depending on the thickness and/or type of materials utilized for the extruded product. If done properly, the extruded product will not be excessively greasy but will instead be crispy and crunchy as the moisture in the food repels the oil. With standard deep frying, the hot oil heats the water within the food, causing it to turn to steam. This water vapor pushes the hot oil bubbles toward the surface of the oil, and allows for only slight surface penetration of the oil with the food product. If the food product is immersed too long, then the oil is allowed to penetrate deeper and an undesirable excessively greasy product results. Therefore, in an embodiment, the extruded product is fried at approximately 340° F., approximately 350° F., approximately 360° F., approximately 370° F., approximately 380° F., or any value therebetween.

In an embodiment, the extruded product described herein is deep fried for less than approximately one minute for a fresh product. In an embodiment, the extruded product described herein is deep fried for approximately 10 seconds, approximately 20 seconds, approximately 30 seconds, approximately 40 seconds, approximately 50 seconds, approximately 60 seconds, approximately 70 seconds, approximately 80 seconds, approximately 90 seconds, or any value therebetween. Due to the ultra-high surface area, the extruded product described herein requires only a fraction of the cooking time as standard fried French fries, which usually undergo 1-2 rounds (double frying) of two or more minutes each in the deep fryer. If the product is frozen following extrusion, the frying time may increase.

In an embodiment, the extruded product described herein is baked for approximately 10 minutes, approximately 15 minutes, approximately 20 minutes, approximately 30 minutes, approximately 40 minutes, or any value therebetween. If the product is frozen following extrusion, the cooking time may increase. In an embodiment, the extruded product is baked at approximately 200° F., approximately 250° F., approximately 300° F., approximately 350° F., approximately 400° F., or any value therebetween.

In an embodiment, the extruded product includes at least one liquid. The liquid may be chosen based on the desired properties for the extruded product (e.g., taste, texture, etc.). For example, water, beer, bouillon, carbonated soda (e.g., club soda, lemon lime soda, cola soda, any flavored soda, etc.), tonic water, gravy, fruit or vegetable juice, meat drippings or au jus, liquid cheese or cheese food, honey, sauce or condiment (teriyaki sauce, soy sauce, fish sauce, barbeque sauce, ranch dressing or other salad dressings, ketchup, mustard, etc.) milk or milk products (from cow, goat, rice, nuts, soy, etc. including sour cream, cream, whey, etc.) or the like, may be incorporated as a liquid component in the extruded product.

In an embodiment, the sole fat in the dough of the extruded product is from milk. In an embodiment, whole milk is utilized. In an embodiment, no additional oils, butter, or other fats are added.

In an embodiment, the extruded product includes approximately 0.1% moisture content, approximately 0.5% moisture content, approximately 1% moisture content, approximately 5% moisture content, approximately 10% moisture content, approximately 15% moisture content, approximately 20% moisture content, approximately 25% moisture content, approximately 30% moisture content, approximately 35% moisture content, approximately 40% moisture content, approximately 45% moisture content, approximately 50% moisture content, or any value therebetween.

As described herein, in an embodiment, the extruded product includes dehydrated, pre-gelatinized flakes of potatoes or other starchy food such as yucca, corn, sweet potatoes, carrots, beets, tofu, pinto beans, fava beans, garbanzo beans, or the like may be processed by adapting conventional methods to yield dehydrated, pre-gelatinized flakes. These dehydrated, pre-gelatinized flakes are in turn utilized with various embodiments as described herein. In an embodiment, the extruded product includes approximately 10% dehydrated pre-gelatinized flakes, approximately 20% dehydrated pre-gelatinized flakes, approximately 30% dehydrated pre-gelatinized flakes, approximately 40% dehydrated pre-gelatinized flakes, approximately 50% dehydrated pre-gelatinized flakes, approximately 60% dehydrated pre-gelatinized flakes, approximately 70% dehydrated pre-gelatinized flakes, approximately 80% dehydrated pre-gelatinized flakes, approximately 90% dehydrated pre-gelatinized flakes, or any value therebetween.

In an embodiment, the extruded product includes an ultra-high surface area, resulting in a crispier French fry when fried. The ultra-high surface area is a result of the composition of the extruded product, particularly the texture of the dehydrated pre-gelatinized flakes with a proper moisture level that produces a flaky product once it is extruded. As described herein, a variety of hydrocolloids or starches may be introduced in particular embodiments, and depending on the specific one selected, may result in a crispier product. In an embodiment, the composition and texture of the dough favors an ultra-high surface area extruded product due to the relative “dryness” of the dough. For example, in an embodiment, dehydrated pre-gelatinized potato or other food flakes are mixed with konjac flour or other highly absorbent binder, and a small amount of whole milk. In this particular example, the proteins and fats in the milk assist in binding together the potato flakes and konjac flour, without “soaking” or softening the dough too much. Such a dough composition results in an extruded product with a “fluffiness” as it emerges from the extrusion die, and is maintained while fried or baked. Likewise, if the extruded product is shaped or molded, the dough composition retains the “dryness” or “fluffiness” characteristic of the ultra-high surface area that allows for an exceptionally crisp product upon frying.

In an embodiment, the dough is mixed in such a way as to increase the surface area of the final extruded product. For example, mixing produces air holes in the dough that are forced to the surface during the extrusion process or ruptured due to the shear stresses, thus forming a mottled or pitted surface of the extruded product. In an embodiment, the micro tears, micro pits, and micro bubbles associated with a product whose dough has been mixed in order to create are bubbles, produces an extruded product with an ultra-high surface area.

In an embodiment, the dough is extruded through a die of desired cross-section, and creates an extrusion product from the compressive and shear stresses and the dough is forced through the die. In an embodiment, the extrusion may be performed with a hot, warm, or cold product. In an embodiment, the extrusion product is cut along the continuum at any desired point, depending on the desired outcome. In an embodiment, a die is utilized that creates an ultra-high surface area, including an octagon, hexagon, star, wavy circle, pyramid, and the like.

### EXAMPLE

### Example 1

Extrusion dough was made with the following ingredients:

100 g dehydrated potato flakes (with no other ingredients added)

300 g whole milk

5 g of glucomannan flour OR 2.5 g konjac flour

Flavorings (tomato powder, cheese, spices, etc.) 5 g-25 g

The dough was made by first mixing the dry and liquid ingredients, and kneading until thoroughly combined. Flavorings were added to taste but not to excess such that the dough tears when kneading. The dough was then allowed to rest for 5 minutes in order to rehydrate. The dough was then either extruded through a die press that cracks and roughens the surface, or the dough was shaped by hand the surface was scored to create cracks or ridges. The extruded or shaped product was fried in canola oil at 340-350° F. for approximately less than one minute but for no more than two minutes.

Konjac flour is processed from Konnyaku root and includes soluble dietary fiber that consists mainly of hydrocolloidal polysaccharide (glucomannan), and is considered a “low carb” food. It is considered a vegetarian replacement for gelatin. The dough and extruded product of this protocol are gluten-free, and vegetarian.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
combining 1 part dehydrated pre-gelatinized starchy food flakes, 3 parts liquid, and 0.025 parts binder to form a dough;
extruding the dough through a die press; and
cooking the extruded product.

2. The method of claim 1, wherein the dehydrated pre-gelatinized starchy food flakes are derived from one or more of potatoes, yucca, corn, sweet potatoes, carrots, beets, tofu, pinto beans, fava beans, garbanzo beans, or the like.

3. The method of claim 1, wherein the liquid includes one or more of water, beer, bouillon, carbonated soda, tonic water, gravy, fruit or vegetable juice, meat drippings or au jus, liquid cheese or liquid cheese food, honey, sauce or condiment, milk or milk product, or the like.

4. The method of claim 1, wherein the binder includes at least one of konjac flour or meal, soy flour or meal, wheat flour or meal, nut flour or meal, hempseed flour or meal, flax flour or meal, barley flour or meal, black chia seed flour or meal, rice flour or meal, brown rice flour or meal, corn flour or meal, oat flour or meal, coconut flour or meal, wheat germ meal, quinoa flour or meal, coffee flour or meal, buckwheat flour or meal, or the like.

5. The method of claim 1, wherein cooking the extruded product includes deep frying, or baking.

6.-8. (canceled)

9. The method of claim 1, further including filling the dough prior to extruding.

10. The method of claim 9, wherein the filling includes at least one condiment or sauce.

11. The method of claim 10, wherein the condiment or sauce includes at least one of ketchup, mustard, soy sauce, gravy, horseradish, teriyaki sauce, or ranch dressing or other salad dressing.

12. The method of claim 10, wherein the filling includes at least one flavoring.

13. The method of claim 10, wherein the filling includes at least one fruit or vegetable or a puree thereof.

14. The method of claim 10, wherein the filling includes at least one meat.

15. The method of claim 14, wherein the meat includes at least one of chicken, beef, pork, lamb, or fish.

16. The method of claim 14, wherein the meat includes hot dogs.

17.-21. (canceled)

22. The method of claim 1, further including adding one or more flavorings to the dough prior to extruding.

23. The method of claim 22, wherein adding one or more flavorings includes intermixing the one or more flavorings in the dough.

24. (canceled)

25. The method of claim 1, wherein extruding the dough with a die press includes extruding the dough with a multi-faceted die press for high surface area of the extruded product.

26. A method, comprising:
combining dehydrated pre-gelatinized potato flakes, milk, and konjac flour to form a dough;
extruding the dough through a die press; and
deep frying the extruded product.

27.-34. (canceled)

35. The method of claim 26, further including shaping the dough following extrusion.

36. The method of claim 26, wherein the shaping includes folding, bending, coning, or imprinting.

37. A dough composition, comprising:
about 1 part dehydrated pre-gelatinized starchy food flakes,
about 3 parts liquid, and

38. The food product made from the dough composition of claim 37.

39. The dough composition of claim 37, wherein the dehydrated pre-gelatinized starchy food flakes are derived from one or more of potatoes, yucca, corn, sweet potatoes, carrots, beets, tofu, pinto beans, fava beans, or garbanzo beans.

40. The dough composition of claim 37, wherein the liquid includes one or more of water, beer, bouillon, carbonated soda, tonic water, gravy, fruit or vegetable juice, meat drippings or au jus, liquid cheese or liquid cheese food, honey, sauce or condiment, milk or milk product, or the like.

41. The dough composition of claim 37, wherein the binder includes at least one of konjac flour or meal, soy flour or meal, wheat flour or meal, nut flour or meal, hempseed flour or meal, flax flour or meal, barley flour or meal, black chia seed flour or meal, rice flour or meal, brown rice flour or meal, corn flour or meal, oat flour or meal, coconut flour or meal, wheat germ meal, quinoa flour or meal, coffee flour or meal, buckwheat flour or meal, or the like.

42. The dough composition of claim 37, further including a filling.

43. The dough composition of claim 42, wherein the filling includes at least one condiment or sauce.

44. The dough composition of claim 43, wherein the condiment or sauce includes at least one of ketchup, mustard, soy sauce, gravy, horseradish, teriyaki sauce, or ranch dressing or other salad dressing.

45. The dough composition of claim 42, wherein the filling includes at least one flavoring.

46. (canceled)

47. The dough composition of claim 42, wherein the filling includes at least one fruit or vegetable or a puree thereof.

48. The dough composition of claim 42, wherein the filling includes at least one meat.

49. The dough composition of claim 48, wherein the meat includes at least one of chicken, beef, pork, lamb, or fish.

50. The dough composition of claim 48, wherein the meat includes hot dogs.

51. The dough composition of claim 37, further including at least one flour or meal.

52. The dough composition of claim 51, wherein the flour or meal includes at least one of soy flour or meal, wheat flour or meal, nut flour or meal, hempseed flour or meal, pecan flour or meal, flax flour or meal, barley flour or meal, black chia seed flour or meal, rice flour or meal, brown rice flour or meal, corn flour or meal, oat flour or meal, coconut flour or meal, wheat germ meal, quinoa flour or meal, coffee flour or meal, or buckwheat flour or meal.

53.-55. (canceled)

56. A food product, comprising:
an extruded, cooked dough,
wherein the dough includes
about 50% to about 100% dehydrated pre-gelatinized starchy food flakes,
about 100% to about 300% milk, and
about 0.5% to about 3.5% konjac flour or about 1% to about 6% glucomannan flour.

57. The food product of claim 56, wherein cooked includes fried or baked.

58.-61. (canceled)

62. The food product of claim 56, wherein the food product is gluten-free.

63. The dough composition of claim 37, wherein the dough is gluten-free.
